(19) United States
(12) Patent Application Publication
(10) Pub. No.: US 2010/0297897 A1
(43) Pub. Date: Nov. 25, 2010

(54) INFLATABLE LIFERAFT

(75) Inventor: Christian Ibsen, Tonder (DK)

Correspondence Address: WOOD, HERRON & EVANS, LLP, 2700 CAREW TOWER, 441 VINE STREET, CINCINNATI, OH, 45202, US

(73) Assignee: Viking Life-Saving Equipment A/S, Esbjerg (DK)

(21) Appl. No.: 12/809,768

(22) PCT Filed: Dec. 18, 2008
(86) PCT No.: PCT/DK2008/050322

§ 371 Date: Jul. 30, 2010

(30) Foreign Application Priority Data
Dec. 21, 2007 (DK) 200701868

(51) Int. Cl. B63B 35/613; B23P 17/04

(52) U.S. Cl. 441/40; 29/428

(57) ABSTRACT

The present invention relates to an inflatable liferaft comprising at least a first inflatable flotation tube layer, a second inflatable flotation tube layer, said first and second flotation tube layers being adapted to be arranged substantially above each other, said inflatable tube layers extending circumferentially for providing a substantially ring-shaped area, and a bottom element which is adapted to provide a bottom to the substantially ring-shaped area. Furthermore, each tube layer comprises at least two inflatable tubes, said inflatable tubes being connected to each other at their ends so that each tube layer extends continuously around the ring-shaped area. The present invention also relates to a method for assembling an inflatable liferaft as well as a method for manufacturing an inflatable tube for use in an inflatable liferaft.

### TECHNICAL FIELD OF THE INVENTION

The present invention relates to an inflatable liferaft comprising at least a first inflatable flotation tube layer, a second inflatable flotation tube layer, said first and second flotation tube layers being adapted to be arranged substantially above each other, said inflatable tube layers extending circumferentially for providing a substantially ring-shaped area, and a bottom element which is adapted to provide a bottom to the substantially ring-shaped area.

The present invention also relates to a method for assembling an inflatable liferaft as well as a method for manufacturing an inflatable tube for use in an inflatable liferaft.

### BACKGROUND ART

The inflatable tubes of the prior art inflatable liferafts are divided into a plurality of airtight compartments so that the liferaft exhibits enough buoyancy even in circumstances where the liferaft leaks air from one or more compartments. This is a statutory requirement, since the liferafts often are exposed to many impacts against the vessel side during evacuation procedures, whereby they may hit an obstacle, which may puncture the inflatable tube. Also, often the evacuations take place during heavy weather conditions, which may enhance the risk of puncturing the liferaft.

For manufacturing the divided inflatable tubes, a fabric is provided which has predetermined dimensions; often it is a rectangular fabric. Furthermore, pieces of materials having also predetermined configurations are provided, said pieces being used for internal bulkheads inside the inflatable tubes and intended to divide the inflatable tube into compartments. Thus, when the inflatable tube is assembled, the fabric is lined up, then the bulkhead pieces are aligned with the predetermined distances between them. Subsequently, the gluing procedure starts where the bulkheads are glued to the fabric on the side which becomes the inside of the inflatable tube. Hereinafter the sides of the fabric are connected while the bulkhead still is being glued so that a cylindrical shape of the inflatable tube is obtained. Then the sides of the fabric are sealed. This procedure continues until a complete ring-shaped inflatable tube is created.

This is an extremely time-consuming manufacturing procedure. Furthermore, it is very difficult to secure that the internal bulkheads are completely airtight and even check whether this actually is the case. There is thus a need for providing an inflatable liferaft which facilitates the manufacturing as well as the assembly processes especially concerning the inflatable tubes dividing into compartments.

### SUMMARY OF THE INVENTION

An object of the present invention is to wholly or partly overcome the above disadvantages and drawbacks of the prior art. More specifically, it is an object to provide an inflatable liferaft which facilitates the manufacturing of the same.

It is also an object of the present invention to provide an inflatable liferaft having inflatable tubes, which easily may be controlled and checked for leakages.

The above objects, together with numerous other objects, advantages and features, which will become evident from the below description, are accomplished by a solution in accordance with the present invention by each tube layer comprising at least two inflatable tubes, said inflatable tubes being connected to each other at their ends so that each tube layer extends continuously around the ring-shaped area.

Hereby it is obtained that the time-consuming internal dividing of the inflatable tubes into compartments is avoided. The present invention breaks with many years' understanding of how an inflatable liferaft is to be assembled. Furthermore, the working positions for the persons assembling the inflatable liferaft according to the invention have been considerable improved, and may be more ergonomically correct than them in the prior art.

The matter is that the flotation layers of the inflatable liferaft according to the invention are built up of at least two inflatable tubes. These inflatable tubes do not contain any internal bulkhead, but are themselves only one compartment. When the inflatable tubes are connected at their ends to each other they will create an uninterrupted ring-shaped tube, which will constitute the hull side of the inflatable liferaft. Thus, when two or more, depending on the intended capacity of the liferaft, are connected, the liferaft will comprise a plurality of separate compartments, and thereby the statutory requirements will be fulfilled as well.

Furthermore, the separate inflatable tubes may easily be controlled for any leakages before they are assembled into the inflatable liferaft, since only exterior control is necessary.

The term “at their ends” is in this context to be construed as both on the ends and in the vicinity of the ends, i.e. a distance from the end, for instance on the outer side of the inflatable tubes.

The term “continuously” is in this context to be construed as the layers are extending without any spaces or distances between the incorporated inflatable tubes. Each layer is thus completely sealed.

In a preferred embodiment according to the invention, the inflatable tubes may be detachable or securely connected at their ends.

The term “detachable” is in this context to be construed as the fact that the inflatable tubes may be separated after they have been assembled and subsequently be attached again.

The term “securely” is in this context to be construed as the fact that the inflatable tubes are attached and connected to each other and that no subsequent detachment is possible without damaging the tubes.

According to the invention, the separate inflatable tubes at their ends may comprise corresponding connection means. Hereby an easy way to assembly of the ends of the inflatable tubes is obtained.

Furthermore, the connection means may be arranged on the ends of the separate inflatable tubes and/or near the end at the outer sides of the separate inflatable tubes.

Advantageously, the connection means may be zips, groove/flange connection, he/she connections or the like.

Furthermore, the connection means may be securely attached after the connection.

According to the invention, the connection means may be sealed after the connection so that the connection is tightly closed and leakage of water through the connection means is avoided. In addition, the ends of the separate inflatable tubes may be welded or glued together.

According to the invention, a reinforcement element may be applied partial or fully around the connection of the inflatable tubes and subsequently welded and/or glued to the inflatable tubes. By applying the reinforcement element the strength of the connection may be enhanced.

Also, the connections of the inflatable tubes in each flotation tube layer may be sealed so that the flotation tube layers are extending continuously for creating a closed and sealed ring.

According to the invention, the inflatable tubes may be made of fabric elements so that they obtain substantially cylindrical shapes.

Furthermore, the ends of the inflatable tube may be closed and sealed by welding and/or gluing the cylindrical fabric element together.

Additionally, the ends of the inflatable tubes may be geometrically locked, for instance by folding, before the welding and/or gluing. This is especially expedient in the circumstances where the inflatable tubes are made of materials which are difficult to weld.

Moreover, the cylindrical fabric element at the ends of the inflatable tubes may be pressed together before they are welded or glued. Hereby an easy straightforward method for closing of the ends of the inflatable tube is obtained. Also, the cylindrical fabric element at the ends of the inflatable tubes may be folded inwards so that the thicknesses of the fabric element are abutting, and hereinafter the abutment is welded and/or glued. The term “thicknesses” is in this context to be construed as thickness width of the fabric element.

According to the invention, a strip may be welded and/or glued onto the closures of the ends of the inflatable tubes for enhancing the sealing and protecting the closure.

Advantageously, the inflatable tubes may be made of a polymeric material, such as natural rubber (NR), polyurethane (PU), thermoplastic poly urethane (TPU), butyl rubber (BR), polyvinylchloride (PVC), polychloroprene (CR), polyethylene (PE), or a combination thereof.

According to the invention, a valve may be arranged between the ends of the separate inflatable tubes so that airtight passage between the inflatable tubes is provided. The valve may be a one-way valve, two-way valve or three-way valve or any other suitable valve.

Furthermore, one or more inflatable tube layer(s) may be arranged in connection with the first and second inflatable tube layers.

According to the invention, the inflatable tube layers are connected mainly via the bottom element. Hereby is obtained that the assembly of the liferaft is facilitated.

The present invention also relates to a first method for assembling an inflatable liferaft according to the present invention. Said method comprising the steps of:
providing at least four inflatable tubes, said inflatable tubes being closed at their ends,
connecting two inflatable tubes at their ends so that a first inflatable tube layer is provided,
connecting two inflatable tubes at their ends so that a second inflatable tube layer is provided,
arranging the second tube layer substantially above the first tube layer, and
connecting the tube layers and a bottom element.

The present invention also relates to a second method for assembling an inflatable liferaft according to present invention. Said method comprising the steps of:
providing at least four inflatable tubes, said inflatable tubes being closed at their ends,
arranging first and second inflatable tubes substantially above each other,
arranging third and fourth inflatable tubes substantially above each other,
connecting the inflatable tubes at their ends so that a first inflatable tube layer and a second inflatable tube layer are provided, said tube layers being arranged above each other, and
connecting the tube layers and a bottom element.

Furthermore, a plurality of inflatable tubes may be incorporated into the liferaft in relation to the intended capacity.

Additionally, the present invention relates to a method to manufacture an inflatable tube for use in an inflatable liferaft according to the present invention. Said method comprising the steps of:
providing a fabric element substantially being rectangular,
connecting and sealing the long sides of the rectangular fabric element for providing a tube having a substantially cylindrical shape, and
closing the ends of the cylindrical tube.

Furthermore, the connecting and sealing of the long sides of the rectangular fabric element and/or the closing of the ends of the substantially cylindrical tube may be performed by gluing and/or welding.

Additionally, the ends of the cylindrical tube may be geometrically locked, for instance by folding, before the welding and/or gluing step.

Also, the cylindrical fabric element at the ends of the inflatable tubes may be pressed together before they are welded or glued.

Moreover, the cylindrical fabric element at the ends of the inflatable tubes may be folded inwards so that the thicknesses of the fabric element are abutting, and hereinafter the abutment is welded and/or glued.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows an inflatable liferaft according to the invention,

FIGS. 2-4 show different embodiments of inflatable tubes,

FIG. 5 shows a connection of two inflatable tubes at their ends,

FIG. 6 shows a wrapping element applied to the outside of the connection between two inflatable tubes, and

FIG. 7 shows in a cross-sectional view the two inflatable layers connected mainly via the bottom element.

All the figures are highly schematic and not necessarily to scale, and they show only parts which are necessary in order to elucidate the invention, other parts being omitted or merely suggested.

### DESCRIPTION OF PREFERRED EMBODIMENTS

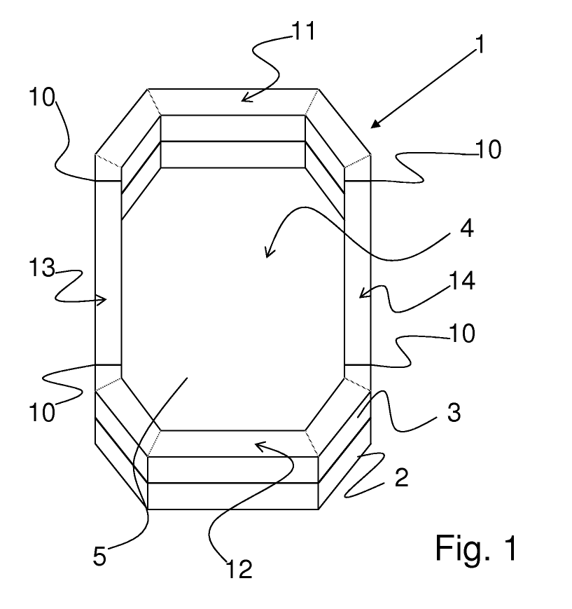

In FIG. 1 an inflatable liferaft 1 is shown schematically. Said liferaft 1 is in this embodiment shown without a canopy. The inflatable liferaft 1 comprises a first inflatable flotation tube layer 2 and a second inflatable flotation tube layer 3. The first and second tube layers 2, 3 are adapted to be arranged substantially above each other. They extend circumferentially for providing a substantially ring-shaped area 4. The inflatable liferaft 1 also comprises a bottom element 5 which is adapted to provide a bottom to the substantially ring-shaped area 4.

According to the present invention each tube layer comprises at least two inflatable tubes, said inflatable tubes being connected to each other at their ends so that each tube layer extends continuously around the ring-shaped area.

The liferaft 1 shown in FIG. 1 comprises in this embodiment four inflatable tubes in each tube layer 2, 3. The ends of said inflatable tubes are connected at the connection points 10 so that each layer extends endlessly around the ring-shaped area 4. The number of inflatable tubes incorporated in each tube layer of the inflatable liferaft depends on the intended capacity of the liferaft 1. The liferaft 1 is here shown having two end sections 11, 12 and two side sections 13, 14. Each section constitutes one inflatable tube in each tube layer, thus, the liferaft comprises two separate compartments, substantially placed above each other, in each section. The end sections 11, 12 of the liferaft 1 constitute nearly a semicircle, in this embodiment, due to manufacturing facilitation, with straight tube parts connected with corners. Within the inventive idea these straight tube parts may as well be separate, inflatable tubes connected with their ends, so that the entire liferaft 1 is divided into several compartments in each tube layer. This is especially expedient when the liferaft 1 has a high capacity.

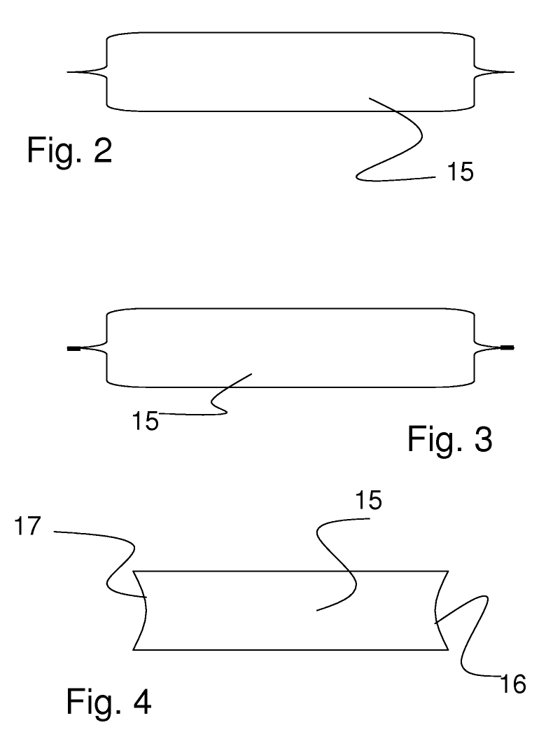

In FIG. 2, an inflatable tube 15 is shown. The inflatable tubes 15 according to the invention may be made of a fabric element so that they obtain substantially cylindrical shapes having substantially a circular cross-section configuration. However, they may as well have other configurations, such as substantially square-formed, elliptic or similar. The inflatable tube 15 shown in FIG. 2 may be manufactured according to the below-mentioned manufacturing method by the ends of the inflatable tube being closed and sealed by welding and/or gluing the cylindrical fabric element together. The matter in this embodiment is that the cylindrical fabric element at the ends of the inflatable tube 15 is pressed together before being welded or glued. The inflatable tube 15 is in this embodiment as well as the below-mentioned shown in inflated state.

Furthermore, in some cases, it is expedient to geometrically lock the ends of the inflatable tubes, for instance by pressing the cylindrical fabric element together and then folding it one or more times. Hereinafter the welding and/or gluing may be performed. An embodiment wherein the end is geometrically locked is schematically shown in FIG. 3. This is especially convenient when the inflatable tube is made of a material which is difficult or impossible to weld in, since the peelable forces at the end may be considerable when the tube is inflated.

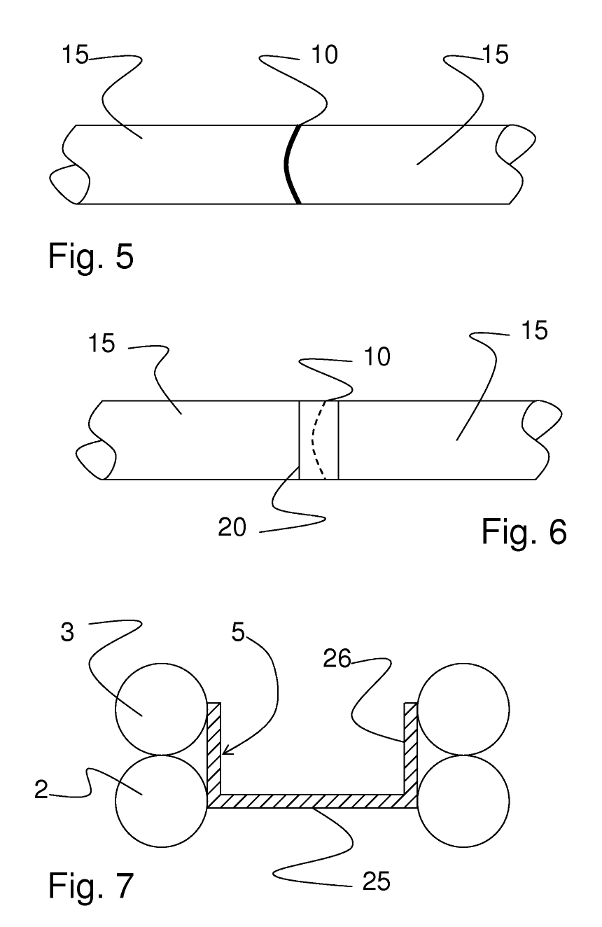

In FIG. 4, another embodiment of an inflatable tube 15 is shown. The ends of the inflatable tube 15 is made by the cylindrical fabric element at the ends of the inflatable tube 15 being folded inwards so that the thicknesses of the fabric element are abutting, and hereinafter the abutment is welded and/or glued. In the side view shown in FIG. 4, the ends 16, 17 of the inflatable tube 15 have concave configuration, however, if the inflatable tube 15 is turned 90 degrees it will have a convex configuration. Thus it is expedient, in assembly of the inflatable tubes 15 shown in FIG. 4 at their ends, to turn one of the inflatable tubes 90 degrees in relation to the other inflatable tube, since the convex configuration substantially will fit into the concave configuration, which is shown in FIG. 5.

Furthermore, a strip (not shown) may be welded and/or glued onto the closures of the ends of the inflatable tubes 15 for enhancing the sealing and protecting the closure.

In FIG. 5, two inflatable tubes 15 are shown connected at one of their ends. The inflatable tubes 15 are in this embodiment the same as the one shown in FIG. 4. The separate inflatable tubes 15 may preferably comprise corresponding connection means (not shown) at their ends. These connection means may be any means suitable for providing fixation and hold of the connection 10 as well as withstanding the pull forces which occur in the connection 10. The connection means may for instance be zips, groove/flange connection, he/she connections or the like, however, for the moment, zips are preferred, since they exhibit the desired properties as well as they are easy to mount on or at the ends of the inflatable tubes as well as to assemble during the manufacturing/assembling of the inflatable liferaft according to the invention. When the inflatable tubes are being connected they may be deflated. If the connection means, for instance, are arranged at a distance from the end of the tube, i.e. on the outer side of the tubes, then, when the tubes are being inflated, the inflating gas inside the inflated tubes will provide for the ends of the inflated tubes to be forced together while the connection means provide for the inflated tubes are fixated in relation to each other and is kept in this position. The connection means may, for instance, extend around the periphery of the inflatable tubes.

Furthermore, the connection means may be securely attached after the connection, i.e. it will not be possible to detach the connection afterwards. Also, it is an advantage if the connection means are being sealed after the connection.

According to the invention, the ends of the inflatable tubes may as be welded or glued together.

In FIG. 6, a connection 10 (indicated with a dotted line) of two inflatable tubes 15 is shown. In this embodiment, a reinforcement element 20 is applied fully around the connection 10 of the inflatable tubes 15 and subsequently welded and/or glued to the inflatable tubes 15. Hereby it is obtained that the reinforcement element enhances the strength of the connection 10 as well as helps to withstand the pull forces between the inflatable tubes 15, which occur while the liferaft is being inflated as well as during use. The reinforcement element may as well be partial applied around the connection.

Advantageously, the inflatable tubes may be made of a polymeric material, such as natural rubber (NR), polyurethane (PU), thermoplastic poly urethane (TPU), butyl rubber (BR), polyvinylchloride (PVC), polychloroprene (CR), polyethylene (PE), or a combination thereof. Furthermore, due to the present invention a larger variety of materials may be used to manufacture the inflatable liferaft, since the assembling of the inflatable tubes is facilitated. Additionally, different types of materials may be incorporated in different inflatable tubes, since with the present invention it is now possible, via the connection means, to connect earlier non-compatible materials, whereby the overall properties as well as performance of the inflatable liferaft may be altered and/or enhanced. Furthermore, by the present invention it is possible to streamline the production of the inflatable liferafts since the assembly of the liferafts is facilitated and, in view of material specific handling procedures, may be limited. Thus, less manufacturing as well as handling procedures is obtained, and especially the time-consuming internal dividing of the inflatable tubes via bulkheads are avoided.

Within the inventive idea, a valve (not shown) may be arranged between the ends of the separate inflatable tubes 15 so that airtight passage between the inflatable tubes is provided. The valve may be a one-way valve, two-way valve or three-way valve.

FIG. 7 shows a cross-sectional view of one embodiment of the inflatable liferaft according to the invention. In FIG. 7, it is easily deducible that the second tube layer 3 is arranged above the second tube layer 2. Furthermore, the bottom element 5 comprises in this embodiment a floor part 25, which is substantially horizontal, and side part 26, which extends from the floor part 25 upwards in a substantially vertical direction so that the bottom element 5 substantially has the configuration as a vessel. In this embodiment, the two tube layers 2, 3 may be arranged separately above each other and being mutually connected mainly via the bottom element 5. Hereby it is obtained that several of the time-consuming connection procedures of the tube layers to each other are avoided, whereby the overall assembling procedures of the inflatable liferaft are facilitated and improved.

Furthermore, one or more inflatable tube layer(s) (not shown) may be arranged in connection with the first and second inflatable tube layers for providing additional buoyancy to the liferaft as well as protection against puncture of the first and second tube layers 2, 3.

The present invention also relates to a first method for assembling an inflatable liferaft 1 according to the present invention. Said method comprising the steps of:
providing at least four inflatable tubes 15, said inflatable tubes 15 being closed at their ends,
connecting two inflatable tubes 15 at their ends so that a first inflatable tube layer 2 is provided,
connecting two inflatable tubes 15 at their ends so that a second inflatable tube layer 3 is provided,
arranging the second tube layer 3 substantially above the first tube layer 2, and
connecting the tube layers 2, 3 and a bottom element 5.

The present invention also relates to a second method for assembling an inflatable liferaft 1 according to present invention. Said method comprising the steps of:
providing at least four inflatable tubes 15, said inflatable tubes 15 being closed at their ends,
arranging first and second inflatable tubes 15 substantially above each other,
arranging third and fourth inflatable tubes 15 substantially above each other,
connecting the inflatable tubes 15 at their ends so that a first inflatable tube layer 2 and a second inflatable tube layer 3 are provided, said tube layers 2, 3 being arranged substantially above each other, and
connecting the tube layers 2, 3 and a bottom element 5.

Furthermore, a plurality of inflatable tubes 15 may be incorporated into the liferaft 1 in relation to the intended capacity.

Additionally, the present invention relates to a method for manufacturing an inflatable tube 15 for use in an inflatable liferaft 1 according to the present invention. Said method comprising the steps of:
providing a fabric element substantially being rectangular,
connecting and sealing the long sides of the rectangular fabric element for providing a tube having a substantially cylindrical shape, and
closing the ends of the cylindrical tube 15.

Furthermore, the connecting and sealing of the long sides of the rectangular fabric element and/or the closing of the ends of the substantially cylindrical tube may be performed by gluing and/or welding.

Additionally, the ends of the cylindrical tube may be geometrically locked, for instance by folding, before the welding and/or gluing step.

Also, the cylindrical fabric element at the ends of the inflatable tubes may be pressed together before they are being welded or glued.

Moreover, the cylindrical fabric element at the ends of the inflatable tubes may be folded inwards so that the thicknesses of the fabric element are abutting, and hereinafter the abutment is welded and/or glued.

Although the invention above has been described in connection with preferred embodiments of the invention, it will be evident for a person skilled in the art that several modifications are conceivable without departing from the invention as defined by the following claims.

1. An inflatable liferaft comprising at least a first inflatable flotation tube layer, a second inflatable flotation tube layer, said first and second flotation tube layers being adapted to be arranged substantially above each other, said inflatable tube layers extending circumferentially for providing a substantially ring-shaped area, and a bottom element which is adapted to provide a bottom to the substantially ring-shaped area, wherein each tube layer comprises at least two inflatable tubes, said inflatable tubes being connected to each other at their ends so that each tube layer extends continuously around the ring-shaped area.

2. The inflatable liferaft according to claim 1, wherein the inflatable tubes are detachable or securely connected at their ends.

3. The inflatable liferaft according to claim 1, wherein the separate inflatable tubes at their ends comprise corresponding connection means.

4. The inflatable liferaft according to claim 3, wherein the connection means are arranged on the ends of the separate inflatable tubes and/or near the end at the outer sides of the separate inflatable tubes.

5. The inflatable liferaft according to claim 3, wherein the connection means are zips, groove/flange connection, he/she connections or the like.

6. The inflatable liferaft (1) according to claim 3, wherein the connection means are securely attached after the connection.

7. The inflatable liferaft according to claim 3, wherein the connection means are sealed after the connection.

8. The inflatable liferaft according to claim 6, wherein the ends of the separate inflatable tubes are welded or glued together.

9. The inflatable liferaft according to claim 1, wherein a reinforcement element is applied partial or fully around the connection of the inflatable tubes and subsequently welded and/or glued to the inflatable tubes.

10. The inflatable liferaft according to claim 1, wherein the connections of the inflatable tubes in each flotation tube layer are sealed so that the flotation tube layers extend continuously for creating a closed and sealed ring.

11. The inflatable liferaft according to claim 1, wherein the inflatable tubes are made of a fabric element so that they obtain substantially cylindrical shapes.

12. The inflatable liferaft according to claim 11, wherein the ends of the inflatable tube are closed and sealed by welding and/or gluing the cylindrical fabric element together.

13. The inflatable liferaft according to claim 12, wherein the ends of the inflatable tubes are geometrically locked, for instance by folding, before the welding and/or gluing.

14. The inflatable liferaft according to claim 12, wherein the cylindrical fabric elements at the ends of the inflatable tubes are pressed together before they are being welded or glued.

15. The inflatable liferaft according to claim 12, wherein the cylindrical fabric element at the ends of the inflatable tubes is folded inwards so that the thicknesses of the fabric element are abutting, and hereinafter the abutment is welded and/or glued.

16. The inflatable liferaft according to claim 12, wherein a strip is welded and/or glued onto the closures of the ends of the inflatable tubes for enhancing the sealing and protecting the closure.

17. The inflatable liferaft according to claim 1, wherein the inflatable tubes are made of a polymeric material, such as natural rubber (NR), polyurethane (PU), thermoplastic poly urethane (TPU), butyl rubber (BR), polyvinylchloride (PVC), polychloroprene (CR), polyethylene (PE), or a combination thereof.

18. The inflatable liferaft according to claim 1, wherein a valve is arranged between the ends of the separate inflatable tubes so that airtight passage between the inflatable tubes is provided.

19. The inflatable liferaft according to claim 18, wherein the valve is a one-way valve, two-way valve or three-way valve.

20. The inflatable liferaft according to claim 1, wherein one or more inflatable tube layer(s) is/are arranged in connection with the first and second inflatable tube layers.

21. The inflatable liferaft according to claim 1, wherein the inflatable tube layers are connected mainly via the bottom element.

22. A method for assembling an inflatable liferaft, comprising:
providing at least four inflatable tubes, said inflatable tubes being closed at their ends,
connecting two inflatable tubes at their ends so that a first inflatable tube layer is provided,
connecting two inflatable tubes at their ends so that a second inflatable tube layer is provided,
arranging the second tube layer substantially above the first tube layer, and
connecting the tube layers and a bottom element.

23. A method for assembling an inflatable liferaft, comprising:
providing at least four inflatable tubes, said inflatable tubes being closed at their ends,
arranging first and second inflatable tubes substantially above each other,
arranging third and fourth inflatable tubes substantially above each other,
connecting the inflatable tubes at their ends so that a first inflatable tube layer and a second inflatable tube layer are provided, said tube layers being substantially arranged above each other, and
connecting the tube layers and a bottom element.

24. The method according to claim 22, wherein a plurality of inflatable tubes are incorporated into the liferaft in relation to the intended capacity.

25. A method to manufacture an inflatable tube for use in an inflatable liferaft, comprising:
providing a fabric element substantially being rectangular,
connecting and sealing the long sides of the rectangular fabric element for providing a tube having a substantially cylindrical shape, and
closing the ends of the cylindrical tube.

26. The method according to claim 25, wherein the connecting and sealing of the long sides of the rectangular fabric element and/or the closing of the ends of the substantially cylindrical tube is/are performed by gluing and/or welding.

27. The method according to claim 25, wherein the ends of the cylindrical tube are geometrically locked, for instance by folding, before the welding and/or gluing step.

28. The method according to claim 25, wherein the cylindrical fabric elements at the ends of the inflatable tubes are pressed together before they are welded or glued.

29. The method according to claim 25, wherein the cylindrical fabric element at the ends of the inflatable tubes is folded inwards so that the thicknesses of the fabric element are abutting, and hereinafter the abutment is welded and/or glued.
